(19) United States
(12) Patent Application Publication
(10) Pub. No.: US 2026/0027531 A1
(43) Pub. Date: Jan. 29, 2026

(54) BRINE MIXING SYSTEMS AND METHODS

(71) Applicant: Schlumberger Technology Corporation, Sugar Land, TX (US)

(72) Inventors: Miguel Angel Lopez, Sugar Land, TX (US); Rod William Shampine, Sugar Land, TX (US)

(21) Appl. No.: 18/783,786

(22) Filed: Jul. 25, 2024

(51) Int. Cl. B01F 35/82; B01D 15/08; B01F 23/40; B01F 23/45; B01F 23/70; B01F 35/21; B01F 35/213; B01F 35/22; B01F 35/83; C22B 3/24; C22B 3/44

(52) U.S. Cl. CPC B01F 35/82; B01F 23/45; B01F 23/49; B01F 23/702; B01F 23/708; B01F 35/213; B01F 35/2132; B01F 35/2203; B01F 35/831; B01F 35/833; C22B 3/24; C22B 3/44; B01D 15/08

(57) ABSTRACT

A system is provided that includes an intake system configured to supply a blended well fluid to a metal extraction system. The intake system includes a manifold including a plurality of fluid inlets, an internal flow path coupled to the plurality of fluid inlets, and a fluid outlet coupled to the internal flow path. The intake system also includes a plurality of sensors used to obtain sensor feedback of one or more parameters of the plurality of well fluids. The plurality of flow controls is coupled to each of the plurality of fluid inlets and the plurality of flow controls to adjust a blend of the one more parameters in the blended well fluid including metal within a concentration range used for metal extraction by the metal extraction system.

### BACKGROUND

The present disclosure generally relates to systems and methods for mixing brine from one or more wells to form a compositional blend for lithium extraction. More specifically, the present disclosure is directed to a manifold and a mixing system to control the compositional blend of brine from the one or more wells.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Lithium is a valuable element in energy storage. Electrical storage devices, such as batteries and supercapacitors, use lithium to mediate the storage and release of chemical potential energy as electrical current. As a demand for renewable, but non-transportable, energy sources (e.g., solar and wind energy grows), a demand for technologies to store energy generated using such sources also grows.

The mining industry employs a variety of techniques to extract lithium from minerals (e.g., hard rock mining) or lithium-containing fluid sources (e.g., brines, such as a geothermal brine, a continental brine, or an oilfield brine). Various pieces of equipment may be used to process and extract lithium from lithium-containing fluid sources. However, such lithium-containing fluid sources may have varied compositions due to differences in subsurface geology. Each of the various pieces of equipment has a certain operating envelope in which it performs optimal lithium extraction. Therefore, the various pieces of equipment may face challenges processing lithium-containing fluid sources of various compositions. As such, there is a need to control lithium-containing fluid source composition to match an operating range of lithium processing equipment.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In certain embodiments, a system is provided that includes an intake system to supply a blended well fluid to a metal extraction system. The intake system includes a manifold including a plurality of fluid inlets used to receive a plurality of well fluids from a plurality of production wells, an internal flow path coupled to the plurality of fluid inlets, and a fluid outlet coupled to the internal flow path, wherein the fluid outlet outputs the blended well fluid that combines the plurality of well fluids. The intake system also includes a plurality of sensors used to obtain sensor feedback of one or more parameters of the plurality of well fluids, wherein at least one of the plurality of sensors is coupled to each of the plurality of fluid inlets, and the one or more parameters include a metal concentration and a plurality of flow controls used to control fluid flows of the plurality of well fluids into the manifold based on the sensor feedback. The plurality of flow controls is coupled to each of the plurality of fluid inlets to adjust a blend of the one more parameters in the blended well fluid, and the blended well fluid comprises metal within a concentration range used for lithium extraction by the metal extraction system.

In certain embodiments, a method includes supplying a blended well fluid to a metal extraction system from an intake system comprising a manifold. The manifold receives a plurality of well fluids from a plurality of production wells into a plurality of fluid inlets coupled to an internal flow path of a manifold of an intake system and outputs the blended well fluid that combines the plurality of well fluids from an outlet of the manifold. The intake system also monitors a plurality of sensors to obtain sensor feedback of one or more parameters of the plurality of well fluids. The plurality of sensors is coupled to each of the plurality of fluid inlets, and the one or more parameters include a metal concentration. The intake system also controls a plurality of flow controls to control fluid flows of the plurality of well fluids into the manifold based on the sensor feedback, wherein at least one of the plurality of flow controls is coupled to each of the plurality of fluid inlets, the plurality of flow controls is configured to adjust a blend of the one more parameters in the blended well fluid, and the blended well fluid comprises metal within a concentration range configured for metal extraction by the metal extraction system.

In certain embodiments, a system includes an intake system used to supply a blended well fluid to a lithium extraction system and including a manifold, wherein the manifold comprises a plurality of fluid inlets that receive a plurality of well fluids from a plurality of production wells, an internal flow path coupled to the plurality of fluid inlets, and a fluid outlet coupled to the internal flow path, wherein the fluid outlet outputs the blended well fluid that combines the plurality of well fluids; and a controller having a processor, a memory, and instructions stored on the memory and executable by the processor to monitor a plurality of sensors to obtain sensor feedback of one or more parameters of the plurality of well fluids, wherein at least one of the plurality of sensors is coupled to each of the plurality of fluid inlets, and the one or more parameters include a lithium concentration and control a plurality of flow controls to control fluid flows of the plurality of well fluids into the manifold based on the sensor feedback, wherein at least one of the plurality of flow controls is coupled to each of the plurality of fluid inlets, the plurality of flow controls is configured to adjust a blend of the one more parameters in the blended well fluid, and the blended well fluid comprises lithium within a concentration range configured for lithium extraction by the lithium extraction system.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram illustrating a lithium extraction system including an intake system, in accordance with an embodiment of the present disclosure;

FIG. 2 is a schematic diagram illustrating the intake system of FIG. 1, in accordance with an embodiment of the present disclosure;

FIG. 3 is a schematic embodiment of an electronic display screen displaying a graphical user interface (GUI) with various data generated by the intake system, in accordance with aspects of the present disclosure;

FIG. 4 is a process for calculating a target portion of one or more well fluids to generate a blended well fluid for use in a construction plan for a facility, in accordance with an embodiment of the present disclosure;

FIG. 5 is a process for controlling a flow of one or more produced streams to a mixing system and providing a stream from the intake system for lithium extraction, in accordance with an embodiment of the present disclosure;

FIG. 6 is a process for operating the intake system to provide a blended well fluid for extraction of lithium for use in a product, in accordance with an embodiment of the present disclosure; and

FIG. 7 is a process for performing pretreatment of one or more produced fluid streams and providing a blended well fluid for lithium extraction, in accordance with an embodiment of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

As used herein, the term “processing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM).

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “continuous”, “continuously”, or “continually” are intended to describe operations that are performed without any significant interruption. For example, as used herein, control commands may be transmitted to certain equipment every five minutes, every minute, every 30 seconds, every 15 seconds, every 10 seconds, every 5 seconds, or even more often, such that operating parameters of the equipment may be adjusted without any significant interruption to the closed-loop control of the equipment. In addition, as used herein, the terms “automatic”, “automated”, “autonomous”, and so forth, are intended to describe operations that are performed are caused to be performed, for example, by a computing system (i.e., solely by the computing system, without human intervention). Indeed, although certain operations described herein may not be explicitly described as being performed continuously and/or automatically in substantially real time during operation of the computing system and/or equipment controlled by the computing system, it will be appreciated that these operations may, in fact, be performed continuously and/or automatically in substantially real time during operation of the computing system and/or equipment controlled by the computing system to improve the functionality of the computing system (e.g., by not requiring human intervention, thereby facilitating faster operational decision-making, as well as improving the accuracy of the operational decision-making by, for example, eliminating the potential for human error), as described in greater detail herein.

As described above, lithium extraction may be performed to generate lithium for use in various products of manufacture. Currently, lithium is approximately $20,000 per metric ton, as such there is motivation to extract lithium from streams. With this in mind, as large-scale lithium processing facilities come on board, such lithium processing facilities may call for an input stream with a high volume (e.g., greater than a single stream) of production fluid to achieve production scales that are economically viable. As such, lithium-containing fluid sources (e.g., brines) may be provided to a lithium processing facility from multiple wells in a given field. In this manner, the lithium processing facility may extract lithium from one or more produced fluids generated by one or more wellbores. Traditionally, a wellbore is formed by drilling through an earth formation, circulating drilling fluids through a drill pipe and drill bit into the wellbore, and subsequently flowing cuttings upward in an annulus between the drill pipe and the earth formation, facilitating the removal of the cuttings from the wellbore. After drilling operations are complete, the wellbore may be prepared for production operations. Each production well may generate a produced fluid (e.g., production fluid, reservoir fluid) from the earth formation having a distinct composition. Compositions of produced fluids may include various concentrations of minerals, hydrocarbons, water, salt, and the like. Additionally and/or alternatively, the produced fluids may include various temperatures, pressures, and flow rates as a result of production environments. As such, there is a need to analyze differences between produced fluids to ensure lithium extraction processes may be performed efficiently and continually in a controlled manner.

To ensure efficient and continual extraction of lithium processing facilities, equipment may be designed and constructed for installation in the lithium processing facility in order to extract lithium at predicted rates. As such, equipment of lithium processing facilities may be designed to operate within an optimal envelope related to a composition, a temperature, a pressure, a flow rate, and the like of the input stream. Therefore, in some instances, if there is a wide variability in a composition of the inlet stream, the equipment may not be able to perform in an optimum fashion. As such, a need exists for controlling the composition of the inlet stream of the lithium processing facility.

Accordingly, techniques of the present disclosure may be used to generate a blended well fluid of a controlled composition to allow equipment of a lithium extraction facility to operate within an optimal operation envelope. It should be noted, that the lithium extraction system is one non-limiting embodiment and that additional and/or alternative metal extraction system may be considered. An intake system, such as on-site or near the lithium extraction facility, is described herein that enables monitoring and analysis of one or more produced streams from multiple wells or networks of wells. In this manner, as a well field is developed and new wells are brought online, compositional differences of the produced streams may be assessed and controlled. The intake system may include a manifold to control a flow of the produced streams (e.g., produced fluids) to a mixing system. The mixing system may be used to produce the blended well fluid to the lithium production facility. In some embodiments, the intake system may analyze one or more parameters (e.g., composition, salinity, temperature, pressure, flow rate, etc.) of the produced fluids and calculate a range of parameters for the blended well fluid based on the optimal operation envelope of equipment of the lithium processing facility.

In some embodiments, the one or more parameters analyzed by the intake system may include a compositional makeup of the produced fluids. For example, the parameters may include a concentration of lithium and other components, such as calcium (Ca), magnesium (Mg), aluminum (Al), manganese (Mn), iron (Fe), and silica, or a combination thereof present in the produced fluids. Further, in some instances, the produced fluids may include water, hydrocarbons (HC) (e.g., water-soluble hydrocarbons, or hydrocarbons in an emulsion), additional elements, or a combination thereof. In this way, one or more sensors of intake system may generate sensor feedback data indicative of the parameters of the produced fluids. The manifold of the intake system may control a flow of each produced fluid based on the sensor feedback data. As such, produced fluids may be provided to the mixing system to generate the blended well fluid.

In some embodiments, the mixing system may include one or more tanks, one or more fluid loops, one or more agitators, or a combination thereof, that may produce and/or store the blended well fluid. The blended well fluid may be provided to the lithium processing facility for lithium extraction. In some embodiments, the lithium processing facility may include a direct lithium extraction (DLE) process. In general operation, the DLE process may load a medium (e.g., a lithium-sorbent material) with lithium from the inlet source (e.g., blended well fluid). Depleted fluid (e.g., lithium depleted) from which the lithium has been stripped may be displaced and an unloading fluid is provided to the medium. The unloading fluid extracts or unloads the media to a minimum lithium content. A lithium rich stream (i.e., unloading fluid loaded with lithium from the medium) may be further processed and used to produce lithium containing products.

In some embodiments, the intake system may use historical data, simulations, artificial intelligence, data from a supervisory system, or a combination thereof to determine an optimal composition of the inlet stream. As such, in some instances, a computer model may be used to provide instructions to control the manifold and the mixing system to generate the optimal composition the blended well fluid (e.g., control the flowrate of each of the produced fluids provided to the mixing system) based on the composition, a temperature, a pressure, a salinity, a flow rate, additional parameters of each of the produced fluids. In certain embodiments, optimization of the intake system operation may be informed by modeling the intake system using machine learning. As such, one or more parameters of the produced fluids may be fed to a machine learning model to provide instructions to actuators of controlled valves of the manifold to control flow of produced fluids to the mixing system to produce blended well fluid. In some instances, the intake system may interface with the supervisory system that may include data related to subsurface geography of wellbores from which the produced fluids are generated. As such, the supervisory system may provide predictions of lithium content and/or additional parameters to the intake system.

In certain embodiments, the optimal composition may maximize a lithium concentration of the blended well fluid while minimizing a concentration of one or more additional components, and/or minimizing a flowrate of the inlet source while maximizing an amount of recovered lithium in the lithium processing facility. Further, in some instances, the intake system may minimize a water content of the inlet stream, and/or control energy consumption (e.g., optimizing the use of renewable energy sources while minimizing the use of fossil fuel energy sources over a given period). As such, the intake system may maintain a ratio of the lithium concentration in the blended well fluid to a predetermined concentration and/or a predetermined ratio with respect to additional components of the produced fluids. In this manner, the equipment of the lithium processing facility may be controlled to operate at optimal operation conditions.

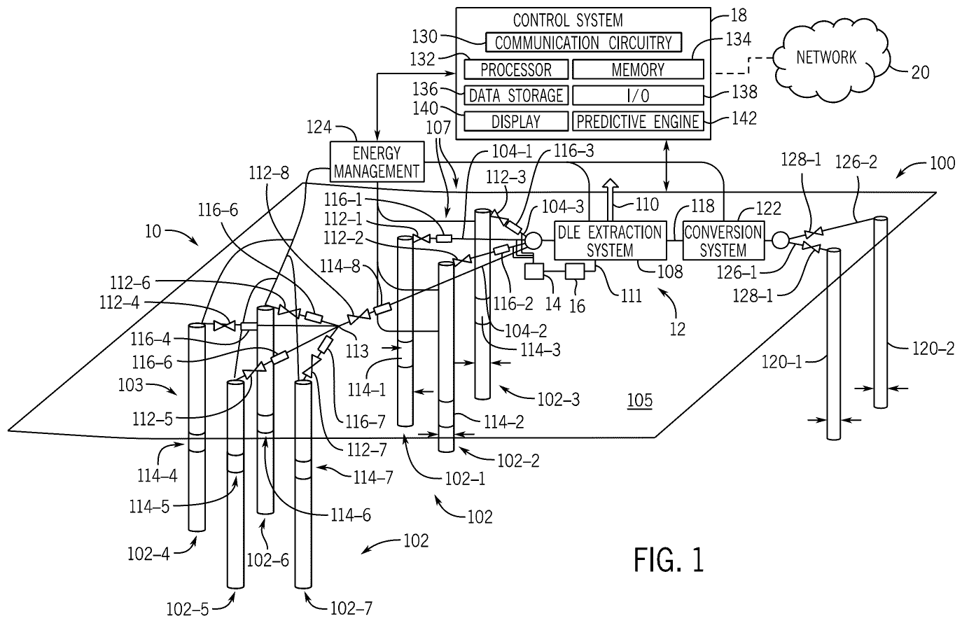

With this in mind, FIG. 1 is a schematic diagram illustrating a system 10 including an intake system 12. The intake system 12 may include a manifold 14, a mixing system 16 (e.g., fluid mixer), a control system 18, a network 20, one or more additional components (e.g., flow control system, pretreatment system). The system 10 includes a plurality of production wells 102. The production wells 102 may include a first production well 102-1, a second production well 102-2, a third production well 102-3, a fourth production well 102-4, a fifth production well 102-5, a sixth production well 102-6, a seventh production well 102-7, and/or one or more additional wells. As shown, the fourth production well 102-4, the fifth production well 102-5, the sixth production well 102-6, and the seventh production well 102-7 may be a part of one or more well clusters 103. The production wells 102 and/or the well clusters 103 may provide a plurality of produced fluids 104 (e.g., production fluids, wellbore fluids, reservoir fluids). The produced fluids 104 may include a first produced fluid 104-1, a second produced fluid 104-2, a third produced fluid 104-3, a fourth produced fluid 104-4, a fifth produced fluid 104-5, a sixth produced fluid 104-6, a seventh produced fluid 104-7, and/or one or more additional produced fluids. The produced fluids 104 may flow in piping 107 in fluid connection with each the production wells 102.

In some embodiments, the production wells 102 may extend through an earth formation 105. The earth formation 105 may include or define one or more lithium-containing reservoirs. The production wells 102 may be generated during drilling of one or more wellbores through the earth formation 105. In some instances, drilling fluids may be circulated through a drill pipe and drill bit into the wellbore, and may subsequently flow upward in an annulus between the drill pipe and the earth formation, facilitating removal of cuttings from the wellbore. After drilling operations are complete, the wellbore may be completed and prepared for production operations. During production, the wellbore may generate lithium containing produced fluids from the earth formation 105.

In certain embodiments, the produced fluids 104 may be mixed to form a blended well fluid 111 that is provided to a lithium extraction facility 108 to extract lithium, such as in the form of a concentrated lithium material 110. In some embodiments, the intake system 12 may receive the produced fluids 104 at the manifold 14. The intake system 12 may control a flow of the produced fluids 104 to the mixing system 16 based on one or more parameters of the produced fluids 104. The mixing system 16 may mix the produced fluids 104 in a controlled manner to generate the blended well fluid 111. The blended well fluid 111 may be provided to the lithium extraction facility 108 to extract lithium and produce the concentrated lithium material 110.

In certain embodiments, the intake system 12 (e.g., manifold 14, mixing system 16, valves, pumps, and sensors supporting the intake system 12) may be disposed on-site (e.g., within a site or common grounds) with the lithium extraction facility 108, or at least near the lithium extraction facility 108. For example, in certain embodiments, the intake system 12 may be disposed within less than or equal to 2 km, 1 km, 500 meters, or 100 meters of the lithium extraction facility 108. However, in some embodiments, the intake system 12 may be disposed further away from the lithium extraction facility 108. In some embodiments, a first one of the intake systems 12 may be disposed at a well site near a well cluster, while a second one of the intake systems 12 may be disposed at a facility site near the lithium extraction facility 108.

With this in mind, the lithium extraction facility 108 may process the blended well fluid 111 to generate a concentrated lithium material 110 and an effluent 118 having a lower concentration of lithium (e.g., a dilute lithium stream). The lithium extraction facility 108 may include a direct lithium extraction (DLE) system, such as an ion withdrawal process (for instance sorption-desorption, ion exchange or solvent extraction) or an electrochemical process. In some embodiments, the produced fluid 104 from each production well 102 may be in fluid communication with the lithium extraction facility 108 by means of the piping 107. Further, in some embodiments, the production wells 102 may include one or more valves 112. For example, each of the plurality of production wells 102 may be in fluid communication with a respective well 112-1, 112-2, 112-3, 112-4, 112-5, 112-6, 112-7. The valves 112 may include a flow control valve, such as a choke valve, a gate valve, a ball valve, or the like. As such, the valves 112 may be located in the piping 107 of each of the produced fluids 104 such that the flowrate of each of the produced fluids 104 may be controlled by controlling the valves 112. The valves 112 may each include a surface wellhead choke valve. Other types of valves or valves located elsewhere between the reservoir and the DLE process may be used. In some embodiments, the valves 112 are located in the piping 107. In some embodiments, the plurality of valves 112 may be controlled by the intake system 12, the lithium extraction facility 108, or a combination thereof, as discussed herein. For example, the intake system 12 may adjust the valves 112 to adjust a flowrate of produced fluid to the manifold 14. In this manner, the valves 112 may be directly coupled to, housed in, and/or integrated with the manifold 14. As such, control of the valves 112 may be controlled through communication with the manifold 14 by the control system 18. In some embodiments, the well cluster 103 may include a gathering network (e.g., a manifold) in which the production wells 102-4, 102-5, 102-6, 102-7, may merge to form a single stream 113. In some instances, a valve 112-8 may be used to control the single stream 113 of produced fluids from the well cluster 103.

In some embodiments, the system 10 may include one or more electric submersible pumps (ESP) 114. The ESPs 114 may be used to control a flowrate of the produced fluid 104. The illustrated embodiment, includes a first ESP 114-1, a second ESP 114-2, a third ESP 114-3, a fourth ESP 114-4, a fifth ESP 114-5, a sixth ESP 114-6, a seventh ESP 114-7, and an eighth ESP 114-8. In some embodiments, each of the ESPs 114 are configured to individually adjust the flowrate from of the production wells 102, the well clusters 103, and the like. For example, the produced fluid may be increased or decreased by increasing or decreasing the rotation speed (e.g., RPM) of the ESPs 114, respectively.

In some embodiments, the system 10 may include one or more sensors 116 to measure one or more parameters (e.g., fluid parameters), such as a fluid composition (e.g., concentration of lithium, oil, gas, water, etc.), a fluid temperature, a fluid pressure, a salinity, a fluid flow rate, or any combination thereof, at one or more locations from the production wells 102 to the lithium extraction facility 108. Thus, the sensors 116 may include composition sensors (e.g., lithium sensors, oil sensors, gas sensors, water sensors, etc.), temperature sensors, pressure sensors, flow rate sensors, or a combination thereof. The sensors 116 may provide sensor feedback data related to one or more parameters of the production wells 102, the well clusters 103, the produced fluids 104, the valves 112, the ESPs 114, the intake system 12, the manifold 14, the mixing system 16, the lithium extraction facility 108, and one or more additional components of the system 10. For example, the sensors 115 may include surface sensors (Internet of Things (IoT) sensors, gauges, and so forth) and/or downhole sensors, or any combination thereof. The system 10 may include a first sensor 116-1, a second sensor 116-2, a third sensor 116-3, a fourth sensor 116-4, a fifth sensor 116-5, a sixth sensor 116-6, a seventh sensor 116-7, and an eighth sensor 116-8, one or more additional sensors 116, or a combination thereof.

In some embodiments, the sensors 116 may include a fluid test meter, such as a multiphase flow meter (e.g., using full gamma spectroscopy) configured to measure a flowrate and a composition of the produced fluids 104. By way of non-limiting example, the sensors 116 may individually include a Vx Spectra (mark of SLB) surface multiphase flowmeter (commercialized by SLB of Houston, TX, USA). In some embodiments, the sensors 116 may be included in the piping 107 between the production wells 102 carrying the produced fluids 104 and the lithium extraction facility 108. In some embodiments, the sensors 116 may be included in the production wells 102. In certain embodiments, the sensors 116 may be included in the mixing system 16. As such, the sensors 116 may be located in a tank, one or more fluid loops, one or more agitators, one or more additional suitable mixing components, or a combination thereof, of the manifold 14 or the mixing system 16, for instance upstream of the valves 112. For example, the first sensor 116-1 may be configured to measure a first composition of the first produced fluid 104-1 from the first production well 102-1, including a first concentration of lithium in the first produced fluid 104-1. Further, the second sensor 116-2 may be configured to measure a second composition of the second produced fluid 104-2 from the second production well 102-2, including a second concentration of lithium in the second produced fluid 104-2. Similarly, the third sensor 116-3 may be configured to measure a third composition of the third produced fluid 104-3 from the third production well 102-3, including a second concentration of lithium in the third produced fluid 104-3. The first sensor may include a plurality of sensor modules, a first module may be a flow meter and a second module may be a conductivity sensor, a capillary electrophoresis sensor, and the like. The modules may be used to derive directly or indirectly the concentration of lithium. By way of non-limiting example, the concentration of lithium in the produced fluids 104 may be within a range of from about 200 mg/L to about 1,400 mg/L, such as from about 200 mg/L to about 400 mg/L, from about 400 mg/L to about 600 mg/L, from about 600 mg/L to about 800 mg/L, from about 800 mg/L to about 1,000 mg/L, from about 1,000 mg/L to about 1,200 mg/L, or from about 1,200 mg/L to about 1,400 mg/L. However, the disclosure is not so limited, and the concentration of lithium in the produced fluids 104 may be different than that described.

In some embodiments, the sensors 116 of the system 10 may be used to measure a temperature, a pressure, a salinity, a flowrate, or a combination thereof, of the produced fluids 104, the well clusters 103, and the like. Further, the sensors 116 may measure a temperature within each of the production wells 102, a pressure within each of the production wells 102, a temperature of the earth formation 105, or a pressure of the earth formation 105, and the like. Further, the system 10 may include additional sensors for measuring a flowrate of effluent 118 from the DLE system 108.

In certain embodiments, the effluent 118 may be reinjected into the subsurface of the earth formation 105 by the conversion system 122. The conversion system 122 may include at least one pump configured to convert the effluent 118 and provide the effluent 118 to one or more injection wells 120. The injection wells 120 may extend through the earth formation 105 and effluent 118 may be reinjected into the earth formation 105 through the injection wells 120. Reinjection of the effluent 118 into the earth formation 105 and/or a lithium reservoir(s) may facilitate recharging (e.g., increase concentration) of lithium in one or more additional produced fluids of the injection wells 120. As such, the effluent 118 may be directed to one or more different injection wells 120 by means of piping 126 in fluid communication with the injection wells 120. The piping 126 fluidly connecting the effluent 118 to each of the injection wells 120 may each include a valve 128 configured to control a flowrate of the effluent to the injection well 120. It should be noted, that while FIG. 1 illustrates that the system 10 includes two injection wells 120-1, 120-2, more or less injections wells 120 may are envisioned to be fluidly connected to the conversion system 122.

In certain embodiments, the system 10 may include an energy management unit 124. The energy management unit 124 may control the acquisition and allocation of energy to the system 10 including the ESPs 114, the sensors 116, the valves 112, the conversion system 122, and the like. In some embodiments, the energy management unit 124 is connected to one or more energy supply units, such as solar power, wind power, a power grid, internal and external power supply units. Some of the energy supply units may be renewable (e.g., solar, wind) and some of the energy supply units may be non-renewable, such as those based on fossil fuels.

In some embodiments, the control system 18 of the system 10 may be used by the intake system 12 to determine an optimal composition of the blended well fluid 111 provided to the DLE system 108. The control system 18 may be used to receive and analyze sensor feedback data, predictive data, historical data, and the like directly or via the network 20. The control system 18 may be located at the lithium extraction site, one or more production well sites, or at one or more remote locations. The control system 18 may include a communication component 130, a processor 132, a memory 134, a data storage 136, input/output (I/O) ports 138, a display 140, a predictive engine 142, and the like. The network 20 may include transceivers, receivers, and/or transmitters to facilitate data communication to and/or from the control system 18. For example, composition data from the sensors 116 may be transmitted to the control system 18 through the network 20. Further, external data (e.g., data about a geologic formation) may be gathered from a remote system and transmitted to the control system 18 via the network 20. However, in some embodiments, data may be transmitted directly from sensors and/or valves coupled to one or more components of the system 10, such as the valves 112, the pumps 114, and the like. Indeed, the control system 18 may communicate with the components directly and/or through the network 20 in accordance with present embodiments. In certain embodiments, the composition data may be automatically communicated from the sensors 116 to the control system 18 for analysis in real-time, thereby enabling real-time responses (e.g., adjusting flow rates of the manifold 14, adjusting mixing rates of the mixing system 16, controlling the production wells 102, etc.) to information obtained from analysis of the data.

The communication component 130 may be a wireless or wired communication component (e.g., circuitry) that may facilitate communication between the control system 18, various types of devices, components of the system 10, the network 20, and the like. Additionally, the communication component 130 may facilitate data transfer to the control system 18, such that the control system 18 may receive data from the other components depicted in FIG. 1 and the like. The communication component 130 may use a variety of communication protocols, such as Open Database Connectivity (ODBC), TCP/IP Protocol, Distributed Relational Database Architecture (DRDA) protocol, Database Change Protocol (DCP), HTTP protocol, other suitable current or future protocols, or combinations thereof.

The processor 132 may include single-threaded processor(s), multi-threaded processor(s), or both. The processor 132 may process instructions stored in the memory 134. The processor 132 may also include hardware-based processor(s) each including one or more cores. The processor 132 may include general purpose processor(s), special purpose processor(s), or both. The processor 132 may be communicatively coupled to other internal components (such as the communication component 130, the data storage 136, the I/O ports 138, and the display 140).

The memory 134 and the data storage 136 may be any suitable articles of manufacture that can serve as media to store processor-executable code, data, or the like. These articles of manufacture may represent computer-readable media (e.g., any suitable form of memory or storage) that may store the processor-executable code used by the processor 132 to perform the presently disclosed techniques. As used herein, applications may include any suitable computer software or program that may be installed onto the control system 18 and executed by the processor 132. The memory 134 and the data storage 136 may represent non-transitory computer-readable media (e.g., any suitable form of memory or storage) that may store the processor-executable code used by the processor 132 to perform various techniques described herein. It should be noted that non-transitory merely indicates that the media is tangible and not a signal.

The I/O ports 138 may be interfaces that may couple to other peripheral components such as input devices (e.g., keyboard, mouse), sensors, input/output (I/O) modules, and the like. The display 140 may operate as a human machine interface (HMI) to depict visualizations associated with software or executable code being processed by the processor 132. The display 140 may display a flow diagram of the mixing system 16 corresponding to processes of the mixing system 16, alerts/alarms, recommendations associated with the alerts/alarms, etc. In one embodiment, the display 140 may be a touch display capable of receiving inputs from an operator of the control system 18. The display 72 may be any 140 suitable type of display, such as a liquid crystal display (LCD), plasma display, or an organic light emitting diode (OLED) display, for example. Additionally, in one embodiment, the display 140 may be provided in conjunction with a touch-sensitive mechanism (e.g., a touch screen) that may function as part of a control interface for the control system 18.

The predictive engine 142 may use various machine learning algorithms to analyze compositions of the produced fluids 104 and provide instructions on controlling the intake system 12. The predictive engine 142 may utilize one or more predictive models for analysis of the variety of data received by the control system 18. Various types of predictive models may be used to analyze data from variety of resources and generate predictive outputs. For example, the predictive engine 142 may be trained with supervised machine learning technique, i.e., a predictive model is trained with training data that includes input data and desired predictive output (e.g., labeled dataset). The predictive engine 142 may also be trained with unsupervised machine learning technique, i.e., a predictive model is trained with training data that includes input data but without desired predictive output (e.g., unlabeled dataset). The predictive engine 142 may include various types of artificial neural networks (ANN), such as Convolution Neural Networks (CNN), Recurrent Neural Networks (RNN), etc. The control system 18 may also communicate with one or more database, which may store information associated with the system 10, related external resources (e.g., geologic formation history), etc.

It should be noted that the components described above with regard to the system 10 are exemplary components and the system 10 may include additional or fewer components as shown. In addition, although the components are described as being part of the control system 18, the components may also be part of any suitable computing device described herein such as the energy management unit 124, and the like to perform the various operations described herein.

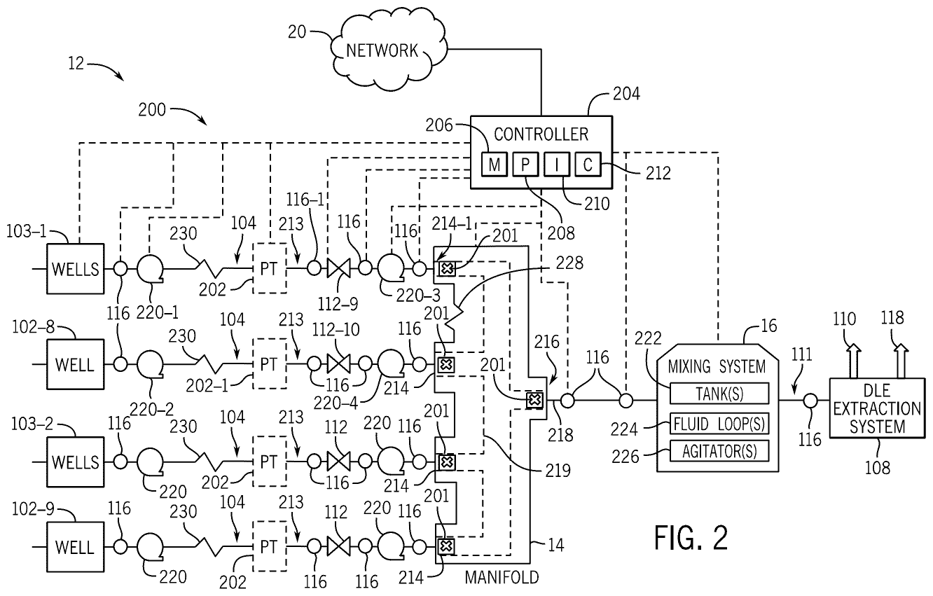

FIG. 2 is a schematic diagram illustrating an embodiment of the intake system 12 of FIG. 1. The intake system 12 may include the manifold 14, the mixing system 16, a flow control system 200 having one or more flow controls 201, a pretreatment system 202, a controller 204, and one or more additional components that may be used to measure and analyze compositions of produced fluids 104 from one or more production wells 102 and/or one or more well clusters 103, vary flowrates of each produced fluids 104 to produce a blended well 111 fluid that may be provided to the DLE system 108. In some embodiments, the controller 204 may be communicatively coupled to various components, actuators, and sensors of the intake system 12. The controller 204 may include a memory 206, a processor 208, instructions 210, and commination circuitry 212 configured to communicate with sensors and various equipment of the intake system 12. For example, the controller 204 may be configured to receive sensor feedback from one or more sensors 116 coupled to the manifold 14, the mixing system 16, the DLE system 108, the flow control system 200, the pretreatment system 202, and/or additional components of the intake system 12 and control said equipment based on sensor feedback data, operating modes, user inputs, computer models, or any combination thereof.

In some embodiments, the controller 204 may acquire composition data from one or more sensors 116 of the intake system 12. The controller 204 may control the intake system 12 based on a composition of the produced fluids 104. As such, the controller 204 may provide instructions to the flow control system 200 to control one or more flowrates of the produced fluids 104 to and/or from the manifold 14. For example, the controller 204 may provide instructions to the flow control system 200 to vary the flowrates and ratios of the produced fluids 104 to the manifold 14, such that different proportions or percentages of the produced fluids 104 can be combined and mixed to achieve the blended well fluid 111. The different proportions or percentages of the produced fluids 104 may account for different fluid compositions, pressures, temperatures, salinity, or any combination thereof, such that the blended well fluid 111 has desired characteristics (e.g., blended fluid composition, pressure, temperature, salinity, etc.). In certain embodiments, the controller 204 may continuously vary the flowrates and ratios of the produced fluids 104 to the manifold 14 in real-time to maintain the desired characteristics of the blended well fluid 111 within upper and lower thresholds. In this manner, the mixing system 16 may produce the blended well fluid 111. A composition of the blended well fluid 111 may be optimized. In some instances, a single component such as lithium concentration, sodium concentration, total dissolved solids, one or more additional components, or a combination thereof may be optimized in the blended well fluid 111. Additionally and/or alternatively, the composition of the blended well fluid 111 may be optimized for multiple additional factors such that various components of the blended well fluid 111 may be within a desired range.

In some embodiments, the manifold 14 of the intake system 12 may be used to control one or more fluid flow paths 213 of the produced fluids 104 from the production wells 102 and/or the well clusters 103. As such, the manifold 14 may include one or more fluid inlets 214 coupled to the produced fluids 104 and one or more fluid outlets 216 coupled to a portion 218 of the intake system 12 including the mixing system 16. As shown, the manifold 14 may receive multiple fluid flow paths 213 of the produced fluids 104 of the produced fluids 104. The manifold 14 may also include an internal flow path 219. The internal flow path 219 of the manifold 14 may couple the produced fluids 104 received from the multiple fluid flow paths 213 at the fluid inlets 214 into a single stream output by the manifold 14 at the fluid outlet 216. In some embodiments, the manifold 14 may be fluidly and/or mechanically coupled to one or more flow controls 201, such as one or more valves 112 and one or more pumps 220, of the flow control system 200. For example, each of the fluid inlets 214 of the manifold 14 may be coupled to one or more flow controls 201, such as one or more valves 112 and one or more pumps 220, thereby enabling independent flow control to each fluid inlet 214 into the manifold 14. In certain embodiments, the flow controls 201 (e.g., valves 112 and pumps 220) may be directly coupled or integrated into the manifold 14, such as directly coupled or integrated into each of the fluid inlets 214. In some embodiments, the flow controls 201 (e.g., valves 112 and pumps 220) may be separate from the manifold 14 and coupled to each of the fluid inlets 214, such as on-site and/or in close proximity to the manifold 14. For example, the flow controls 201 (e.g., valves 112 and pumps 220) may be within less than or equal to 5, 10, 15, 20, 30, 40, 50, or 100 meters of the manifold 14. However, in some embodiments, the flow controls 201 (e.g., valves 112 and pumps 220) may be positioned further away from the manifold 14. In this manner, the manifold 14 and the various flow controls 201 (e.g., valves 112 and pumps 220) may control flow of streams of the produced fluids 104 to the mixing system 16, such that a blend of one or more parameters (e.g., lithium concentration, salinity, temperature, etc.) of the produced fluids 104 can be controlled when producing the blended well fluid 111.

In certain embodiments, the mixing system 16 may be used to mix (e.g., blend) the produced fluids 104 into the blended well fluid 111. Blending of the produced fluids 104 may be achieved by controlling components of the mixing system 16 to produce the blended well fluid 111 of a known composition. The mixing system 16 may include one or more tanks 222 (e.g., storage units), one or more fluid loops 224, one or more agitators 226, one or more additional suitable mixing components, or a combination thereof. For example, the mixing system 16 may include a mixing tank, a mixing valve, a mixing manifold, a flow agitator (e.g., motor driven impeller), a fluid injector, or any combination thereof. The produced fluids 104 provided by the manifold to the portion 218 of the intake system 12 including the mixing system 16 may be mixed in a variety of ways to generate the blended well fluid 111. For example, the produced fluids 104 may be mixed in piping of the intake system 12. Additionally and/or alternatively, one of the fluids loops 224 may be configured to mix produced fluid from the manifold 14 with one or more additional inputs (e.g., water, emulsifying agent). As a further example, one of the agitators 226 may mix the produced fluids 104 until a desired composition is achieved. The mixing system 16 may then provide the blended well fluid 111 of the desired composition to the tanks 222 for storage. In this manner, the blended well fluid 111 may be stored by the mixing system 16 prior to discharge into the DLE system 108.

In some embodiments, the manifold 14 and the mixing system 16 may be communicatively coupled to the flow control system 200 and the controller 204. In this manner, the controller 204 may communicate directly or via the network 20 with the flow control system 200 to control flow of the produced fluids 104 in the fluid flow paths 213, the blended well fluid 111, and/or one or more additional fluid streams. The flow controls system 200 may include the one or more pump 220, the one or move valves 112, one or more ESP pumps 114, a motor, a door or flap, louvers, or other suitable components to control a flow direction and flowrate of the fluid streams 104, 111. For example, the pumps 220 may be electric motor driven pumps, wherein the controller 204 can adjust a speed of the pump to change the flow rate and adjust a rotational direction of the pump to change a flow direction. By further example, the controller 204 can control an electric motor to drive the door, flap, louvers, or the valve 112 between open and closed positions to either enable, disable, or vary the flow rate through the intake system 12. The flow control system 200 may include a pump 220-1 positioned at the well cluster 103-1. As such, the flow control system 200 may directly control a flow of the produced fluids 104 at well pumps of the production wells 102 and/or the well clusters 103. In some embodiments, the flow controls system 200 may control a flow of the produced fluids 104 from the well cluster 103-1. In certain embodiments, the flow control system 200 may include a pump 220-2 positioned at a production well 102-8. In some instances, the flow controls system 200 may control a flow of the produced fluids 104 at an individual well level (e.g., production well 102-8). It should be noted, that while the illustrated embodiment includes four fluid streams directed to the manifold 14 fewer or more fluid streams are envisioned in accordance to be received by the manifold as denoted by a break 228 in the manifold 14.

In some embodiments, the manifold 14 and the mixing system 16 may be combined or separate. As such, in some instances, the manifold 14 and the mixing system 16 may be included in a single piece of equipment (e.g., a single housing). The single piece of equipment may fluidly couple the produced fluids 104 from the production wells 102 to the DLE system 108. In some instances, flow of the produced fluids 104 from the production wells 102 may be directly controlled by the single piece of equipment. In this manner, the single piece of equipment may control the flow of fluid and/or mix the production fluids 104 to produce the blended fluid 111. In some embodiments, the single piece of equipment may include the flow control system 200. As such, the valves 112 and the pumps 220 may be included in the single piece of equipment. In some instances, the single piece of equipment may be controlled by the control system 18. The single piece of equipment including the manifold 14, the mixing system 16, and the flow control system 200 may be installed to control a metal concentration (e.g., lithium concentration) provided to the DLE system 108 from the production wells 102. In some instances, the single piece of equipment may be modular, replaceable, and/or removable. Such single piece of equipment may be easily operable by being connected on-site to fluid outlets of each of the production wells, via a suitable connector.

In certain embodiments, the production wells 102 and/or the well clusters 103 may be located upstream of the intake system 12. As such, the produced fluids 104 may travel over a distance before reaching the manifold 14 and the mixing system 16 of the intake system 12 as denoted by a break 230 in flow of each of the produced fluids 104. In this manner, the flow control system 200 may include a valve 112-9 and a pump 220-3 positioned at the inlet 214-1 of the manifold 14. As such, the flowrate of the produced fluids 104 may be controlled using proportional flow control valves. In some instances, the flow controls system 200 may control a flow of the produced fluids 104 from the well cluster 103-2 at the inlet 214-1 of the manifold 14. Further, in some embodiments, the valve 112-10 and the pump 220-4 may be used to control (e.g., open, close, or vary) the flow rate of the produced fluid 104 from the production well 102-8 into the manifold 14. In certain embodiments, the flow control system 200 may include valves 112 and pumps 220 positioned at the fluid outlet 216 of the manifold 14 that may be used to control (e.g., open, close, or vary) the flow rate of the produced fluid 104 to the portion 218 of the intake system 12 including the mixing system 16. In certain embodiments, the sensors 116 positioned along a flow path of the produced fluids 104 (and/or in the manifold upstream of the control pumps or valve) may indicate to the controller 204 to increase and/or decrease the flow rate by actuating the pumps 220. For example, the flow rate of the produced fluid 104 from the well cluster 103-1 may be decreased by actuating the pump 220-1 and/or the pump 220-3.

In some embodiments, the sensors 116 may measure the composition, a salinity, a temperature, a pressure, a flow rate, or a combination thereof, of the produced fluids 104 at various points of the intake system 12 to direct the manifold 14 and the mixing system 16 to perform such that the blended well fluid 111 has a desired composition. For example, a sensor 116-1 may include a manual sample port which may provide for off-site testing (e.g., lab testing). As such, data from off-site testing may be provided to the controller 204 via the network 20. In some embodiments, the sensors 116 may include one or more automatic sampling and measurement devices, such that real-time measurements can be provided to the controller 204. The automatic sampling and measurement devices may automatically provide composition data directly to the controller 204. The automatic sampling and measurement devices may include an inline sensor, a slipstream sampling unit, a multiplexed sensor (e.g., periodically sample fluid streams from various sources), or a combination thereof.

With the foregoing in mind, the controller 204 may analyze the sensor feedback data from each sensor 116 upstream of the manifold 14 of the intake system 12 and determine a composition of each produced fluid from the production wells 102 and/or the well cluster 103. The controller 204 may define an optimum flowrate of each of the produced fluids to the mixing system 16 to achieve a desired output composition of the blended well fluid 111. In some embodiments, the desired output composition may include an optimized amount of a single component such as lithium concentration, sodium concentration, total dissolved solids, impurity concentration, salinity, and/or one or more additional components of the produced fluids 104. In certain embodiments, the produced fluids 104 from various wells may have different ratios or percentages of materials and/or properties, such as high percentages or concentrations of certain materials, high temperatures, etc., which can be used to boost those materials and/or properties in the blended well fluid 111. For example, a first produced fluid 104 may have a high concentration of lithium and a low salinity, a second produced fluid 104 may have a low concentration of lithium and a high salinity, and a third produced fluid 104 may have a moderate concentration of lithium and/or salinity and a high temperature, wherein the controller 204 may be configured to use a ratio of the first, second, and third produced fluids 104 that uses the first produced fluid 104 to increase the lithium concentration, the second produced fluid 104 to increase the salinity, and the third produced fluid 104 to increase the temperature of the blended well fluid 111. Thus, the controller 204 may simultaneously consider multiple materials and/or properties when controlling the flow rates and/or ratios of the produced fluids 104 being used to generate the blended well fluid 111. Additionally, the controller 204 may continuously vary, in real-time, the flow rates and/or ratios of the produced fluids 104 to generate the blended well fluid 111. In this manner, the blended well fluid 111 may be mixed to form a composition within a desired range of various materials and/or properties. The desired range may correspond to an optimal operation condition of equipment of the DLE system 108. In this way, the blended well fluid 111 may be standardized to increase efficiency, reproducibility, and consistency of lithium extraction processes.

In certain embodiments, the controller 204 may determine an optimum rate combination of the produced fluids 104. In some embodiments, the controller 204 may include first principles logic, machine learning, simulations, digital twin, or a combination thereof to achieve the optimum rate combination. For example, the controller 204 may receive data via the network 20 from a supervisory system that may include additional data about the production wells 102, the well clusters 103, and subsurface characteristics. As such, the data may be used to determine the optimum rate combinations as a factor of an expected composition, salinity, temperature, pressure, flow rate, and the like of sources of the produced fluids 104. For example, in some embodiments a produce well 102-8 may have a higher salinity than a production well 102-9. As such, the controller 204 may direct the flow rate of producing fluids from the production well 102-8 to be greater than the flow rate of the producing fluids of from the production well 102-9 to improve a loading capacity of the blended well fluid 111 and/or to produce a desired impact on processes of the mixing system 16, the pretreatment system 202, or a combination thereof.

In certain embodiments, a well cluster 103-2 may include one or more horizontal wells, one or more long vertical production intervals, or a combination thereof. As such, the controller 204 may control one or more in-flow controllers and/or multiple downhole pumps that may be used to select a mixing ratio of one or more downhole zones of the horizontal wells and/or the long vertical production intervals prior to delivery to a wellhead of the well cluster 103-2. In some embodiments, the controller 204 may receive sensor data and/or data from the supervisory system indicating that a high temperature zone is available in a particular production well. In this manner, the produced fluid of the particular production well may have an elevated temperature. As such, the controller 204 may control the manifold 14 to allow flow of the produced fluid of the particular production well to the mixing system 16. In this manner, mixing of the produced fluid of the particular well may reduce an amount of heating and/or to regulate a temperature of the blended well fluid 111. In some instances, the controller 204 may include offboard processes that may inform one or more local controllers of one or more optimum flowrate setpoints for each incoming produced fluid. In this manner, the intake system 12 may operate continuously to produce an optimum compositional range of the blended well fluid 111.

In some embodiments, the pretreatment system 202 may provide treatment to the produced fluid 104 prior to being received at the fluid inlet 214 of the manifold 14. In certain embodiments, the pretreatment system 202 may provide treatment subsequent to being received by the manifold 14. In yet other embodiments, the pretreatment system 202 may not be used by the intake system 12. In general, the pretreatment system 202 treats one or more fluids to ensure accurate measurements may be acquired by the sensors 116 and equipment health may be maintained. The pretreatment system 202 may include one or more filters, one or more separators, one or more dehydrators, one or more chillers, and the like. For example, a pretreatment system 202-1 may be positioned along a fluid path of the produced fluid 104 from the production well 102-8. In some instances, the production well 102-8 may include an aged well that may output produced fluids with containments that may compromise the health of various components of the intake system 12 and the DLE system 108. As such, the pretreatment system 202-1 may treat the produced fluid 104 and provide a treated fluid 232 to the manifold 14. In some instances, the production well 102-9 may include a new well that produces fluid that may be clean (e.g., impurities below a certain threshold). As such, the intake system 12 may directly flow the produced fluid to the manifold 14 without pretreatment. It should be noted, that the pretreatment systems 202 as shown may include fewer or more units. Further, in some embodiments, the pretreatment system 202 may include a slip stream that directs the produced fluids 104 to a secondary stream for treatment prior to being discharged to the manifold 14.

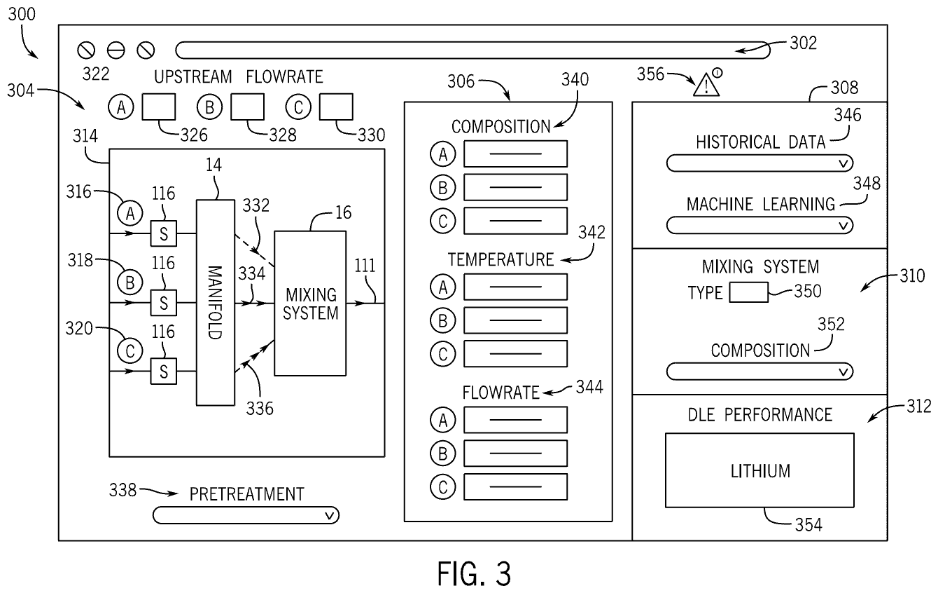

FIG. 3 is an illustrative embodiment of an electronic display screen having a user interface 300 of the intake system 12. The user interface 300 may include a dashboard 302 (e.g., command center) that may be used to visualize the intake system 12, including the manifold 14, the mixing system 16, and various equipment, as well as various data relating the produced fluids 104 and the blended well fluid 111. In this manner, the intake system 12 provides centralized feedback to the users via the dashboard 302. The dashboard 302 may include various widgets (e.g., user interface widgets) providing alerts, notifications, status updates, fluid data, structural data, and the like.

In some embodiments, the various widgets of the dashboard 302 include an intake visualization widget 304, a properties widget 306, a data widget 308, a mixing widget 310, a DLE performance widget 312, one or more additional widgets, or a combination thereof. As shown, the intake visualization widget 304 may be selected to display a representation 314 of one or more production wells and/or clusters 316, 318, 320, the manifold 14, the mixing system 16, the sensors 116, and/or one or more additional components of the intake system 12. The intake visualization widget 304 may include one or more upstream flowrate inputs 322. As such, a user of the intake system and/or the controller 204 may set one or more flowrates 326, 328, 330 of the production wells and/or clusters 316, 318, 320. In some instances, a pretreatment input 338 may be included in the intake visualization widget 304. As such, the user may select if produced fluids are pretreated in one or more portions of the intake system 12.

In certain embodiments, portions of the intake visualization widget 304 may be selected by the user to populate corresponding data in the properties widget 306. For example, a first fluid stream 332, a second fluid stream 334, a third fluid stream 336, and/or an additional element of the intake visualization widget 304 may be selected by the user. In instances in which the first fluid stream 332 is selected, a composition 340, a temperature 342, a flowrate 344, or a combination thereof, may be displayed on the properties widget 306. As shown, the properties widget 306 may include the composition 340, the temperature 342, and the flowrate 344 for each of the production wells and/or clusters 316, 318, 320.

In some embodiments, the data widget 308 may include historical data 346, machine learning data 348, sensor data, and/or one or more additional sources of data. The data widget 308 may be accessed to determine the optimum composition of the blended well fluid 111, determine an optimum range as a goal for the intake system 12, predict a performance of the intake system 12, and the like. The mixing widget 310 may include a type of mixing 350 being performed by components (e.g., tank, fluid loops, fluid injector, agitator) of the mixing system 16. Further, the mixing widget 310 may provide a composition 352 of the blended well fluid 111. In this manner, the user of the dashboard 302 of the intake system 12 may monitor mixing of the produced fluids 104.

The DLE performance widget 312 may include a lithium concentration 354 extracted by the DLE system 108, and/or additional features of the DLE system 108. In this manner, the intake system 12 may analyze a performance of blended well fluid 111. In some embodiments, the intake system 12 may vary an operation of the manifold 14, the mixing system 16, the flow control system 200, the pretreatment system 202, or a combination thereof, based on the performance of the DLE system 108. In some embodiments, the widgets 304, 306, 308, 310, 312 of the user interface 300 of the intake system 12 may generate one or more notifications 356. The notifications 356 may provide the user with one or more messages related to operation of the intake system 12, the DLE system 108, or a combination thereof.

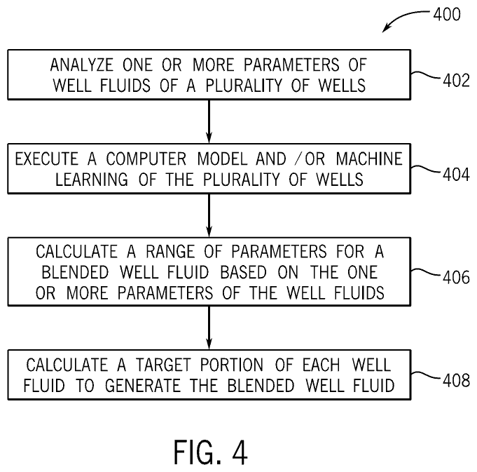

Referring now to FIG. 4, the intake system 12 may perform a process 400 for calculating a target portion of one or more well fluids to generate a blended well fluid for used in a construction plan for a facility. The process 400 may be performed by a computing device or controller disclosed above with reference to FIG. 1 and/or FIG. 2, or any other suitable computing device(s) or controller(s). Furthermore, the blocks of the process 400 may be performed in the order disclosed herein or in any suitable order. For example, certain blocks of the process may be performed concurrently. In addition, in certain embodiments, at least one of the blocks of the process 400 may be omitted.

At block 402 of the process 400, the intake system 12 may analyze one or more parameters of one or more well fluids (e.g., produced fluids 104) of a plurality of wells (e.g., production wells 102). The one or more parameters may include a concentration of lithium, a salinity, a temperature, a pressure, a flow rate, and/or one or more additional parameters. At block 404 of the process 400, the intake system 12 may execute a computer model and/or a machine learning model of the plurality of wells. The computer model may be based on historical data, numerical simulations, supervisory data, geological data, and the like. The machine learning model may be generated using training data from one or more simulated wells, the plurality of wells, one or more historical wells, or a combination thereof. The computer model and/or the machine learning model may be used to predict the range of parameters based on operational ranges of equipment of the DLE system 108.

At block 406 of the process 400, the intake system 12 may calculate a range of parameters for a blended well fluid 111 based on the one or more parameters of the well fluids. The range of parameters may be based on a composition of the well fluids such as the lithium (Li), calcium (Ca), magnesium (Mg), aluminum (Al), manganese (Mn), iron (Fe), and silica, or a combination thereof. At block 408 of the process 400, the intake system 12 may calculate a target portion of each well fluid to generate the blended well fluid 111. The target portion of each well may include an amount of well fluid from each well that may be provided to the mixing system 16. In some embodiments, the target portion may be controlled by the manifold 14 and/or the flow control system 200.

In some embodiments, the process 400 may generate a construction plan for a facility having a DLE system 108 and an intake system having a manifold 14 to provide the blended well fluid 111 to the facility. As such, the construction plan may include specification for one or more pieces of equipment of the facility. Further, the process 400 may implement the construction plan to construct the facility having the DLE system and the intake system 12 having the manifold 14. In this manner, the facility may be constructed to intake the well fluids to extract lithium.

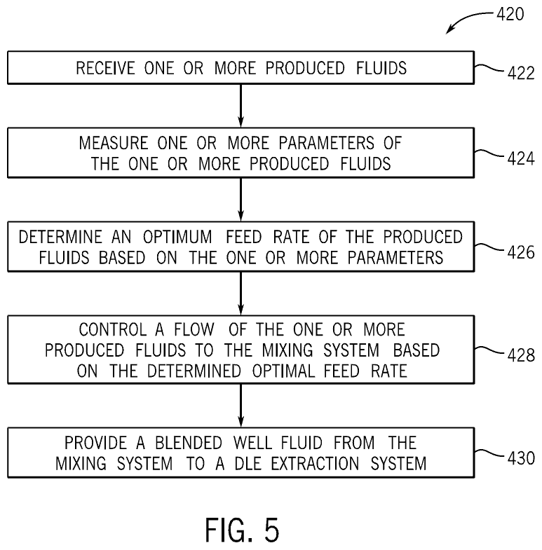

Referring now to FIG. 5, the intake system 12 may perform a process 420 for controlling a flow of one or more produced streams to a mixing system and providing a stream from the intake system for lithium extraction. The process 420 may be performed by a computing device or controller disclosed above with reference to FIG. 1 and/or FIG. 2, or any other suitable computing device(s) or controller(s). Furthermore, the blocks of the process 420 may be performed in the order disclosed herein or in any suitable order. For example, certain blocks of the process may be performed concurrently. In addition, in certain embodiments, at least one of the blocks of the process 420 may be omitted.

At block 422 of the process 420, the intake system 12 may receive one or more produced fluids 104. The produced fluids 104 may be from one or more production wells 102 and/or one or more well clusters 103. At block 424 of the process 420, the intake system 12 may measure one or more parameters of the one or more produced fluids 104. The one or more parameters may include a concentration of various elements, an amount of impurities, a salinity, a temperature, a pressure, a flow rate, and the like. At block 426 of the process 420, the intake system 12 may determine an optimum feed rate of the produced fluids 104, based on the parameters. The optimum feed rate may be controlled to flow the produced fluids 104 into the mixing system 16 to generate the blended well fluid 111 to have a composition within an operating range of equipment of the DLE system 108.

At block 428 of the process 420, the intake system 12 may control a flow of the one or more produced fluids 104 to the mixing system 16 based on the determined optimal feed rate. The flow may be controlled by the flow control system 200, the controller 204, or a combination thereof. At block 430 of the process 420, the intake system 12 may provide a blended well fluid 111 from the mixing system 16 to a DLE system 108. The composition of the blended well fluid 111 may be in the operating range of equipment of the DLE system 108.

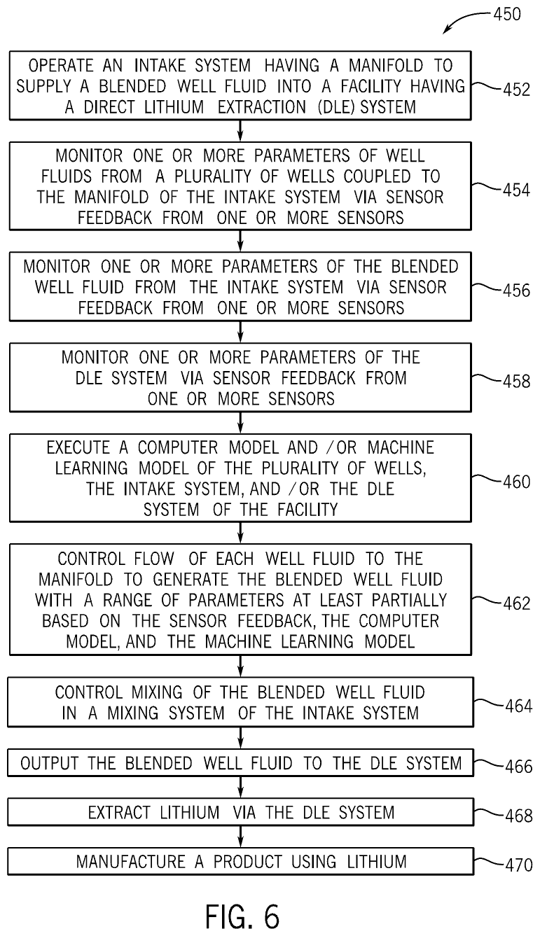

Referring now to FIG. 6, the intake system 12 may perform a process 450 for operating the intake system to provide a blended well fluid for extraction of lithium for use in a product. The process 450 may be performed by a computing device or controller disclosed above with reference to FIG. 1 and/or FIG. 2, or any other suitable computing device(s) or controller(s). Furthermore, the blocks of the process 450 may be performed in the order disclosed herein or in any suitable order. For example, certain blocks of the process may be performed concurrently. In addition, in certain embodiments, at least one of the blocks of the process 450 may be omitted.

At block 452 of the process 450, the system 10 may operate an intake system 12 having a manifold 14 to supply a blended well fluid 111 into a facility having a DLE system 108. The intake system 12 may also include a mixing system 16 with one or more mixing devices to blend the blended well fluid 111 received from the manifold 14. At block 454 of the process 450, the system 10 may monitor one or more parameters of wells fluids from a plurality of wells coupled to the manifold 14 of the intake system 12. At block 456, the system 10 may monitor one or more parameters of the blended well fluid 111 from the intake system 12 via sensor feedback from one or more sensors 116. The one or more sensors 116 may measure a composition, a salinity, a temperature, a pressure, a flow rate, and/or one or more additional parameters of the well fluids.

At block 458 of the process 450, the system 10 may monitor one or more parameters of the DLE system 108 via sensor feedback from one or more additional sensors. The one or more additional sensors may be located on equipment, piping, and the like of the DLE system 108. The parameters of the DLE system 108 may include one or more operating conditions, lithium extraction concentrations, and the like. At block 260, the system 10 may execute a computer model and/or machine learning model of the plurality of wells, the intake system 12, and/or the DLE system 108 of the facility. The computer model may be based on historical data, numerical simulations, supervisory data, market pricing of lithium, energy consumption, geological data, and the like. The computer model and/or the machine learning model may use the parameters of the of the well fluid used to provide instructions to determine an optimum range of the well fluids to generate the blended well fluid 111. In certain embodiments, as the market price of lithium increases, the computer model and/or the machine learning may be configured to use more dilute streams (e.g., lower concentrations of lithium) in the process 450 to provide a blended well fluid for extraction of lithium for use in a product. In contrast, as the market price of lithium decreases, the computer model and/or the machine learning may be configured to use more concentrated streams (e.g., higher concentrations of lithium) in the process 450 to provide a blended well fluid for extraction of lithium for use in a product.

At block 462 of the process 450, the system 10 may control flow of each well fluid to the manifold 14 to generate the blended well fluid 111 with a range of parameters at least partially based on the sensor feedback, the computer model, and the machine learning model. The range of parameters may include a specific concentration of lithium, a threshold amount of impurities, a salinity, and a mixed temperature. At block 464, the system 10 control mixing of the blended well fluid 111 in a mixing system 16 of the intake system 12. The mixing system 16 may include one or more tanks 222, one or more fluid loops 224, one or more agitators 226, a fluid injector, and the like. At block 466, the system 10 may output the blended well fluid 11 to the DLE system 108. At block 468, the system 10 may extract lithium via the DLE system 108. At block 470 of the process 450, the system 10 may manufacture a product using lithium. The product may include batteries, electronics, and the like.

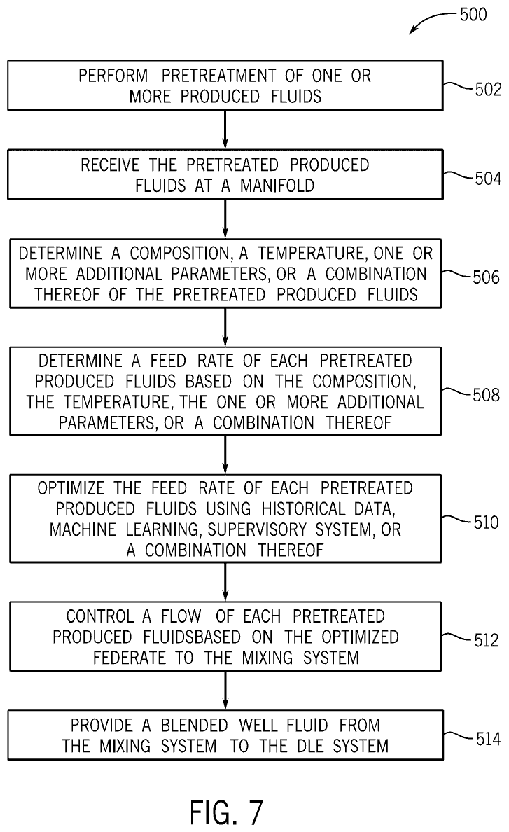

Referring now to FIG. 7, the intake system 12 may perform a process 500 for performing pretreatment of one or more produced fluid streams and providing a blended well fluid for lithium extraction. The process 500 may be performed by a computing device or controller disclosed above with reference to FIG. 1 and/or FIG. 2, or any other suitable computing device(s) or controller(s). Furthermore, the blocks of the process 500 may be performed in the order disclosed herein or in any suitable order. For example, certain blocks of the process may be performed concurrently. In addition, in certain embodiments, at least one of the blocks of the process 500 may be omitted.

At block 502 of the process 500, the intake system 12 may perform pretreatment of one or more produced fluids. The pretreatment may be performed by the pretreatment system 202. At block 504, the intake system 12 may receive the pretreated produced fluids at a manifold 14. At block 506 of the process 500, the intake system 12 may determine a composition, a temperature, a pressure, a flow rate, one or more additional parameters, or a combination thereof of the pretreated streams. At block 508 of the process 500, the intake system 12 may determine a feed rate of each pretreated produced fluids based on the composition, the temperature, the pressure, the flow rate, the one or more additional parameters, or a combination thereof.

At block 510 of the process 500, the intake system 12 may optimize the feed rate of each pretreated produced fluids using historical data, machine learning, a supervisory system, or a combination thereof. At block 512 of the process 500, the intake system 12 may control a flow of each pretreated produced fluids based on the optimized feed rate to the mixing system 16. The flow of each pretreated produced fluids may be controlled by the controller 204 and/or the flow control system 200. At block 514 of the process 500, the intake system 12 may provide a blended well fluid 111 from the mixing system 16 to the DLE system 108.

Technical effects of the disclosed embodiments include an intake system 12 for producing a blended well fluid 111 within an optimum range to a lithium production facility. In certain embodiments, the intake system 12 may be disposed on-site or near a site of the lithium production facility, such that the blended well fluid 111 is produced, monitored, and controlled in proximity to the lithium production facility. Advantageously, by controlling the blended well fluid 111 in proximity to the lithium production facility, the blended well fluid 111 may be controlled (e.g., varied in composition, temperature, pressure, salinity, flow rate, etc.) in quickly (e.g., in real-time) in response to changes or demands in the lithium production facility, thereby helping to improve operations of the lithium production facility. A controller 204 of the intake system 12 may receive sensor feedback from one or more sensors 116 and analyze one or more parameters (e.g., composition, salinity, temperature, pressure, flow rate, etc.) of produced fluids and determine conditions to produce the blended well fluid 111. In some instances, the composition of the blended well fluid 111 may be based on an optimal operation envelope of equipment of the lithium processing facility. In certain embodiments, the range of parameters of the produced fluids may inform construction of the lithium extraction facility. By generating a standardized blended well fluid, the intake system 12 may improve an overall performance and efficiency of the DLE system 108. The disclosed techniques may result in reduced down time during lithium extraction by providing a continuous source of the standardized blended well fluid. Further, deployment of the presently disclosed techniques may provide improved efficiency and performance of lithium extraction from one or more sources.

The subject matter described in detail above may be defined by one or more clauses, as set forth below.

In certain embodiments, a system is provided that includes an intake system to supply a blended well fluid to a metal extraction system. The intake system includes a manifold including a plurality of fluid inlets used to receive a plurality of well fluids from a plurality of production wells, an internal flow path coupled to the plurality of fluid inlets, and a fluid outlet coupled to the internal flow path, wherein the fluid outlet outputs the blended well fluid that combines the plurality of well fluids. The intake system also includes a plurality of sensors used to obtain sensor feedback of one or more parameters of the plurality of well fluids, wherein at least one of the plurality of sensors is coupled to each of the plurality of fluid inlets, and the one or more parameters include a metal concentration and a plurality of flow controls used to control fluid flows of the plurality of well fluids into the manifold based on the sensor feedback. The plurality of flow controls is coupled to each of the plurality of fluid inlets to adjust a blend of the one more parameters in the blended well fluid, and the blended well fluid comprises metal within a concentration range used for metal extraction by the metal extraction system.

The system of the preceding claim, wherein the intake system comprises a fluid mixer fluidly coupled to the outlet of the manifold, and the fluid mixer comprises one or more tanks, one or more agitators, one or more fluid loops, or a combination thereof.

The system of any of the preceding claims, wherein the plurality of flow controls comprises one or more valves, one or more pumps, or a combination thereof.

The system of any of the preceding claims, wherein the plurality of flow controls are directly coupled to the manifold, separate and on-site with the manifold, or a combination thereof.

The system of any of the preceding claims, wherein the one or more parameters further comprise a composition, a concentration of one or more species, a temperature, a salinity, or a combination thereof.

The system of any of the preceding claims, including a controller configured to control the plurality of flow controls in response to the sensor feedback from the plurality of sensors, and the controller is configured to control the blend of the one or more parameters in the blended well fluid to achieve at least the metal within a concentration range.

The system of any of the preceding claims, wherein the controller is further configured to control the blend of the one or more parameters in the blended well fluid to achieve a salinity within a salinity range.

The system of any of the preceding claims, wherein the controller is further configured to control the blend of the one or more parameters in the blended well fluid to achieve a temperature with a temperature range.

The system of any of the preceding claims, wherein the controller is further configured to control a flow rate of each of the plurality of well fluids to the manifold via the plurality of flow controls based on the sensor feedback and at least one of historical data, market pricing of metal, energy consumption, machine learning, a supervisory system.

The system of any of the preceding claims, wherein the controller is further configured to control a flow rate of each of the plurality of well fluids to the manifold via the plurality of flow controls to control the blend of the one or more parameters in the blended well fluid based on an operational range of one or more pieces of equipment of the metal extraction system.

The system of any of the preceding claims, wherein the metal extraction system is a lithium extraction system comprising a sorption-desorption system or an electrochemical system.

In certain embodiments, a method includes supplying a blended well fluid to a metal extraction system from an intake system comprising a manifold. The manifold receives a plurality of well fluids from a plurality of production wells into a plurality of fluid inlets coupled to an internal flow path of a manifold of an intake system and outputs the blended well fluid that combines the plurality of well fluids from an outlet of the manifold. The intake system also monitors a plurality of sensors to obtain sensor feedback of one or more parameters of the plurality of well fluids. The plurality of sensors is coupled to each of the plurality of fluid inlets, and the one or more parameters include a metal concentration. The intake system also controls a plurality of flow controls to control fluid flows of the plurality of well fluids into the manifold based on the sensor feedback, wherein at least one of the plurality of flow controls is coupled to each of the plurality of fluid inlets, the plurality of flow controls is configured to adjust a blend of the one more parameters in the blended well fluid, and the blended well fluid comprises metal within a concentration range configured for metal extraction by the metal extraction system.

The method of the preceding clause, including mixing the blended well fluid in a fluid mixer of the intake system fluidly coupled to the outlet of the manifold, wherein the fluid mixer comprises one or more tanks, one or more agitators, one or more fluid loops, or a combination thereof.

The method of any of the preceding clauses, wherein the plurality of flow controls comprises one or more valves, one or more pumps, or a combination thereof, wherein the one or more parameters comprise a composition, a temperature, a salinity, or a combination thereof.

The method of any of the preceding clauses, wherein controlling the plurality of flow controls to control fluid flows of the plurality of well fluids into the manifold includes controlling the blend of the one or more parameters in the blended well fluid to achieve at least the metal within a concentration range, a salinity within a salinity range, and a temperature with a temperature range.

The method of any of the preceding clauses, wherein the metal extraction system is a lithium extraction system comprising a sorption-desorption system or an electrochemical system, and wherein the lithium extraction system extracts lithium from the blended well fluid via the lithium extraction system coupled to the intake system.

In certain embodiments, a system includes an intake system used to supply a blended well fluid to a lithium extraction system and comprising a manifold, wherein the manifold comprises a plurality of fluid inlets that receive a plurality of well fluids from a plurality of production wells, an internal flow path coupled to the plurality of fluid inlets, and a fluid outlet coupled to the internal flow path, wherein the fluid outlet outputs the blended well fluid that combines the plurality of well fluids. The system also includes a controller having a processor, a memory, and instructions stored on the memory and executable by the processor to monitor a plurality of sensors to obtain sensor feedback of one or more parameters of the plurality of well fluids, wherein at least one of the plurality of sensors is coupled to each of the plurality of fluid inlets, and the one or more parameters include a lithium concentration and control a plurality of flow controls to control fluid flows of the plurality of well fluids into the manifold based on the sensor feedback, wherein at least one of the plurality of flow controls is coupled to each of the plurality of fluid inlets, the plurality of flow controls is configured to adjust a blend of the one more parameters in the blended well fluid, and the blended well fluid comprises lithium within a concentration range configured for lithium extraction by the lithium extraction system.

The system of the preceding clause, wherein the controller is configured to control the blend of the one or more parameters in the blended well fluid to achieve at least the lithium within a concentration range, a salinity within a salinity range, and a temperature with a temperature range.

The system of any of the preceding clauses, wherein the controller is configured to control extraction of lithium from the blended well fluid via the lithium extraction system coupled to the intake system.

In certain embodiments, an apparatus includes a manifold including a plurality of fluid inlets, an internal flow path coupled to the plurality of fluid inlets, and a fluid outlet coupled to the internal flow path, wherein the plurality of fluid inlets receives a plurality of well fluids from a plurality of production wells, and wherein the fluid outlet outputs a blended well fluid that combines the plurality of well fluids. The apparatus also includes a plurality of sensors coupled to manifold, wherein the plurality of sensors is used to obtain sensor feedback about the plurality of well fluids received through the plurality of fluid inlets, a plurality of flow controls coupled to the manifold, wherein the plurality of flow controls is used to control fluid flows of the plurality of well fluids through the plurality of fluid inlets, and a controller coupled to the plurality of sensors and the plurality of flow controls, wherein the controller includes a processor, a memory, and instructions stored on the memory and executable by the processor to control the plurality of flow controls in response to the sensor feedback to control proportions of the plurality of well fluids in the blended well fluid.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

Finally, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
an intake system configured to supply a blended well fluid to a metal extraction system, wherein the intake system comprises:
a manifold comprising:
a plurality of fluid inlets configured to receive a plurality of well fluids from a plurality of production wells;
an internal flow path coupled to the plurality of fluid inlets; and
a fluid outlet coupled to the internal flow path, wherein the fluid outlet is configured to output the blended well fluid that combines the plurality of well fluids;
a plurality of sensors configured to obtain sensor feedback of one or more parameters of the plurality of well fluids, wherein at least one of the plurality of sensors is coupled to each of the plurality of fluid inlets, and the one or more parameters include a metal concentration; and
a plurality of flow controls configured to control fluid flows of the plurality of well fluids into the manifold based on the sensor feedback, wherein at least one of the plurality of flow controls is coupled to each of the plurality of fluid inlets, the plurality of flow controls is configured to adjust a blend of the one more parameters of the blended well fluid, and the blended well fluid comprises metal within a concentration range configured for metal extraction by the metal extraction system.

2. The system of claim 1, wherein the intake system comprises a fluid mixer fluidly coupled to the outlet of the manifold, and the fluid mixer comprises one or more tanks, one or more agitators, one or more fluid loops, or a combination thereof.

3. The system of claim 1, wherein the intake system comprises a pretreatment system, wherein the pretreatment system comprises one or more filters, one or more separators, one or more dehydrators, one or more chillers, or a combination thereof.

4. The system of claim 1, wherein the plurality of flow controls comprises one or more valves, one or more pumps, or a combination thereof.

5. The system of claim 4, wherein the plurality of flow controls are directly coupled to the manifold, separate and on-site with the manifold, or a combination thereof.

6. The system of claim 1, wherein the one or more parameters further comprise a composition, a concentration of one or more species, a temperature, a salinity, or a combination thereof.

7. The system of claim 1, comprising a controller configured to control the plurality of flow controls in response to the sensor feedback from the plurality of sensors, and the controller is configured to control the blend of the one or more parameters in the blended well fluid to achieve at least the metal within a concentration range.

8. The system of claim 7, wherein the controller is further configured to control the blend of the one or more parameters in the blended well fluid to achieve a salinity within a salinity range.

9. The system of claim 7, wherein the controller is further configured to control the blend of the one or more parameters in the blended well fluid to achieve a temperature with a temperature range.

10. The system of claim 7, wherein the controller is further configured to control a flow rate of each of the plurality of well fluids to the manifold via the plurality of flow controls based on the sensor feedback and at least one of historical data, market pricing of the metal, energy consumption, machine learning, a supervisory system.

11. The system of claim 7, wherein the controller is further configured to control a flow rate of each of the plurality of well fluids to the manifold via the plurality of flow controls to control the blend of the one or more parameters in the blended well fluid based on an operational range of one or more pieces of equipment of the metal extraction system.

12. The system of claim 1, wherein the metal extraction system comprises a sorption-desorption system or an electrochemical system.

13. A method, comprising:
supplying a blended well fluid to a metal extraction system from an intake system comprising a manifold, comprising:
receiving a plurality of well fluids from a plurality of production wells into a plurality of fluid inlets coupled to an internal flow path of a manifold of an intake system; and
outputting the blended well fluid that combines the plurality of well fluids from an outlet of the manifold;
monitoring a plurality of sensors to obtain sensor feedback of one or more parameters of the plurality of well fluids, wherein at least one of the plurality of sensors is coupled to each of the plurality of fluid inlets, and the one or more parameters include a metal concentration; and
controlling a plurality of flow controls to control fluid flows of the plurality of well fluids into the manifold based on the sensor feedback, wherein at least one of the plurality of flow controls is coupled to each of the plurality of fluid inlets, the plurality of flow controls is configured to adjust a blend of the one more parameters of the blended well fluid, and the blended well fluid comprises metal within a concentration range configured for metal extraction by the metal extraction system.

14. The method of claim 13, comprising:
mixing the blended well fluid in a fluid mixer of the intake system fluidly coupled to the outlet of the manifold, wherein the fluid mixer comprises one or more tanks, one or more agitators, one or more fluid loops, or a combination thereof.

15. The method of claim 13, wherein the plurality of flow controls comprises one or more valves, one or more pumps, or a combination thereof, wherein the one or more parameters comprise a composition, a temperature, a salinity, or a combination thereof.

16. The method of claim 13, wherein controlling the plurality of flow controls to control fluid flows of the plurality of well fluids into the manifold comprises:
controlling the blend of the one or more parameters in the blended well fluid to achieve at least the metal within a concentration range, a salinity within a salinity range, and a temperature with a temperature range.

17. The method of claim 13, wherein the metal extraction system comprises a sorption-desorption system or an electrochemical system, and wherein the metal extraction system extracts metal ion from the blended well fluid via the metal extraction system coupled to the intake system.

18. An apparatus comprising:
a manifold comprising a plurality of fluid inlets, an internal flow path coupled to the plurality of fluid inlets, and a fluid outlet coupled to the internal flow path, wherein the plurality of fluid inlets receive a plurality of well fluids from a plurality of production wells, and wherein the fluid outlet outputs a blended well fluid that combines the plurality of well fluids;
a plurality of sensors coupled to manifold, wherein the plurality of sensors is configured to obtain sensor feedback about the plurality of well fluids received through the plurality of fluid inlets;
a plurality of flow controls coupled to the manifold, wherein the plurality of flow controls is configured to control fluid flows of the plurality of well fluids through the plurality of fluid inlets; and
a controller coupled to the plurality of sensors and the plurality of flow controls, wherein the controller comprises a processor, a memory, and instructions stored on the memory and executable by the processor to control the plurality of flow controls in response to the sensor feedback to control proportions of the plurality of well fluids in the blended well fluid.

19. The apparatus of claim 18, further comprising a fluid mixer fluidly coupled to an outlet of the manifold and to the fluid outlet, wherein the fluid mixer comprises one or more tanks, one or more agitators, one or more fluid loops, or a combination thereof.

20. The apparatus of claim 18, further comprising a pretreatment system, wherein the pretreatment system comprises one or more filters, one or more separators, one or more dehydrators, one or more chillers, or a combination thereof.

21. The apparatus of claim 18, wherein the plurality of flow controls comprises one or more valves, one or more pumps, or a combination thereof.

22. The apparatus of claim 18, wherein the controller is configured to control the plurality of flow controls to adjust a blend of one or more parameters of the blended well fluid.

23. The apparatus of claim 22, wherein the one or more parameters further comprise a composition, a concentration of one or more species, a temperature, a salinity, or a combination thereof.

24. The apparatus of claim 22, wherein the controller is further configured to control a flow rate of each of the plurality of well fluids to the manifold via the plurality of flow controls based on the sensor feedback and at least one of historical data, market pricing of lithium, energy consumption, machine learning, a supervisory system.
